(19) United States
(12) Patent Application Publication
(10) Pub. No.: US 2025/0284927 A1
(43) Pub. Date: Sep. 11, 2025

(54) METHOD FOR PREDICTING SHORT-TERM WIND POWER OF NEWLY-BUILT WIND POWER PLANT BASED ON SAMPLE MIGRATION

(71) Applicant: GUANGDONG UNIVERSITY OF TECHNOLOGY, Guangdong (CN)

(72) Inventors: Hao YIN, Guangdong (CN); Chen LI, Guangdong (CN); Jiayu RONG, Guangdong (CN); Pengli ZOU, Guangdong (CN)

(73) Assignee: GUANGDONG UNIVERSITY OF TECHNOLOGY, Guangdong (CN)

(21) Appl. No.: 19/073,019

(22) Filed: Mar. 7, 2025

(30) Foreign Application Priority Data
Mar. 8, 2024 (CN) 202410264997.5

(51) Int. Cl. G06N 3/043; G06N 3/0464; G06N 3/08

(52) U.S. Cl. CPC G06N 3/043; G06N 3/0464; G06N 3/08

(57) ABSTRACT

The present invention discloses a method for short-term wind power prediction of a newly-built wind farm based on sample migration, and relates to the technical field of wind power prediction. The method includes: acquiring historical wind power data of the newly-built wind farm and surrounding wind farms of the newly-built wind farm; pre-processing the historical wind power data to obtain a wind power related data matrix; constructing historical day weather feature vector sets, converting the historical day weather feature vector sets into historical day Gram matrices, and constructing a sample set; setting a to-be-predicted day for the newly-built wind farm, and selecting similar day Gram matrices from the sample set, calculating a corresponding similarity weight, and constructing a similarity weight sequence; and setting a training loss function, training a constructed wind power prediction neural network model to obtain a trained wind power prediction neural network model for short-term wind power prediction of the newly-built wind farm to obtain a wind power prediction result. According to the present invention, the accuracy of the wind power prediction of the newly-built wind farm based on the sample migration method is effectively improved, and the generalization capability is strong.

### CROSS-REFERENCE TO RELATED APPLICATION

This application claims the priority benefit of China application serial no. 202410264997.5, filed on Mar. 8, 2024. The entirety of the above-mentioned patent application is hereby incorporated by reference herein and made a part of this specification.

### TECHNICAL FIELD

The present invention relates to the technical field of wind power prediction, and more particularly to a method for short-term wind power prediction of a newly-built wind farm based on sample migration.

### DESCRIPTION OF RELATED ART

In recent years, wind energy, as a renewable energy source, has experienced rapid development. A large number of newly-built wind power stations have been successively integrated into a power system, and large-scale integration of wind power generation has brought a series of challenges to the reliable operation of the power system. Accurate wind power generation prediction is of great significance to ensure the safe and stable operation of the power system.

Machine learning models are heavily dependent on enough training samples for training. For newly-built wind farms, there is not enough sample data for training, while migration learning can transfer historical data of surrounding wind farms with existing knowledge to newly-built wind farms with a small number of samples. However, in the process of migration, there are differences between the historical data of the surrounding wind farms and the data of the newly-built wind farms. If the historical data of the surrounding wind farms are directly migrated to the newly-built wind farms for training, negative migration may occur. At present, in most cases, data with high similarity are selected for migration and the data with low similarity are eliminated according to the similarity between the data of the surrounding wind farms and the data of the newly-built wind farms, which will destroy the time sequence of the data, and the prediction accuracy is closely related to the time scale, so that eliminating the data will not improve the prediction accuracy. Therefore, the existing data migration method is not suitable for the technical field of wind power prediction of the newly-built wind farms, resulting in low prediction accuracy.

### SUMMARY

In order to overcome the above defect of inaccurate wind power predication of a newly-built wind farm by an existing data migration method, the present invention provides a method and system for short-term wind power prediction of a newly-built wind farm based on sample migration, so as to improve the accuracy of short-term wind power prediction of the newly-built wind farm based on a sample migration method.

In order to solve the above technical problem, the technical solution of the present invention is as follows.

The present invention provides a method for short-term wind power prediction of a newly-built wind farm based on sample migration, including:
S1: acquiring historical wind power data of the newly-built wind farm and surrounding wind farms of the newly-built wind farm, where the historical wind power data includes a historical weather data sequence and a historical wind power data sequence;
S2: pre-processing the historical wind power data of each wind farm to obtain a wind power related data matrix of each wind farm;
S3: constructing a historical day weather feature vector set of each wind farm according to the wind power related data matrix of each wind farm, converting the wind power related data matrix of each wind farm into corresponding historical day Gram matrix, and using all the historical day Gram matrices to construct a sample set;
S4: setting a to-be-predicted day for the newly-built wind farm, where the corresponding historical day Gram matrices are to-be-predicted day Gram matrices; and selecting a plurality of historical day Gram matrices similar to the to-be-predicted day Gram matrix from the sample set as similar day Gram matrix;
S5: calculating a corresponding similarity weight for each similar day Gram matrix according to the to-be-predicted day Gram matrices and the similar day Gram matrices, and constructing a similarity weight sequence;
S6: constructing an input sequence based on historical day weather feature vectors and historical wind power data corresponding to similar day Gram matrices, setting a training loss function, training a constructed wind power prediction neural network model, and using the similarity weight sequence to optimize network model parameters to obtain a trained wind power prediction neural network model; and
S7: using the trained wind power prediction neural network model to perform the short-term wind power prediction on the newly-built wind farm to obtain a wind power prediction result.

Preferably, the historical weather data sequence includes a historical wind speed data sequence, a historical wind direction data sequence, and a historical humidity data sequence.

Preferably, the pre-processing the historical wind power data of each wind farm to obtain the wind power related data matrix of each wind farm includes:
performing min-max normalization processing on the historical wind speed data sequence, the historical wind direction data sequence, the historical humidity data sequence and the historical wind power data sequence of each wind farm to obtain processed historical wind speed data, historical wind direction data, historical humidity data and historical wind power data;
performing sine-cosine processing on the processed historical wind direction data to obtain processed historical wind direction sine data and historical wind direction cosine data; and
using the processed historical wind speed data, historical wind direction sine data, historical wind direction cosine data, historical humidity data and historical wind power data of each wind farm to construct a wind power related data matrix of the wind farm:

$${X}_{n} = [ \begin{matrix}{P}_{T}^{t - 1} & {WS}_{T}^{t - 1} & {WDC}_{T}^{t - 1} & {WDS}_{T}^{t - 1} & {H}_{T}^{t - 1} \\ {P}_{T}^{t - 2} & {WS}_{T}^{t - 2} & {WDC}_{T}^{t - 2} & {WDS}_{T}^{t - 2} & {H}_{T}^{t - 2} \\ ⋮ & ⋮ & ⋮ & ⋮ & ⋮ \\ {P}_{T}^{t - b} & {WS}_{T}^{t - b} & {WDC}_{T}^{t - b} & {WDS}_{T}^{t - b} & {H}_{T}^{t - b}\end{matrix} ]$$

in the formula, Xₙ represents a wind power related data matrix of an n^{th} wind farm, P_{T}^{t-1}, P_{T}^{t-2}, . . . , P_{T}^{t-b} represent processed historical wind powers of the n^{th} wind farm at moments t−1, t−2, . . . , t−b respectively, WS_{T}^{t-1}, WS_{T}^{t-2}, . . . , WS_{T}^{t-b} represent processed historical wind speeds of the n^{th} wind farm at moments t−1, t−2, . . . , t−b, respectively, WDC_{T}^{t-1}, WDC_{T}^{t-2}, . . . , WDC_{T}^{t-b} represent processed historical wind direction cosines of the n^{th} wind farm at moments t−1, t−2, . . . , t−b, respectively, WDS_{T}^{t-1}, WDS_{T}^{t-2}, . . . , WDS_{T}^{t-b} represent historical wind direction sines of the n^{th} wind farm at moments t−1, t−2, . . . , t−b, respectively, H_{T}^{t-1}, H_{T}^{t-2}, . . . , H_{T}^{t-b} represent processed historical humidities of the n^{th} wind farm at moments t−1, t−2, . . . , t−b, respectively, and T represents a total moment.

Preferably, the constructing a historical day weather feature vector set of each wind farm according to the wind power related data matrix of each wind farm includes:
obtaining daily wind power related data of each wind farm from the wind power related data matrix of each wind farm to form the historical day weather feature vector set of each wind farm:

$${D}_{n}^{i} = [ \begin{matrix}{a}_{i}^{W S} \\ {a}_{i}^{W D C} \\ {a}_{i}^{W D S} \\ {a}_{i}^{H}\end{matrix} ] = [ \begin{matrix}W {S}_{i}^{t - 1} & W {S}_{i}^{t - 2} & ⋯ & W {S}_{i}^{t - b} \\ W D {C}_{i}^{t - 1} & W D {C}_{i}^{t - 2} & ⋯ & W D {C}_{i}^{t - b} \\ W D {S}_{i}^{t - 1} & W D {S}_{i}^{t - 2} & ⋯ & W D {S}_{i}^{t - b} \\ {H}_{i}^{t - 1} & {H}_{i}^{t - 2} & ⋯ & {H}_{i}^{t - b}\end{matrix} ]$$

the formula, Dₙⁱ represents a historical day weather feature vector set of a n^{th} wind farm on an i^{th} day, αᵢ^{WS} represents a historical wind speed vector of the n^{th} wind farm on the i^{th} day, αᵢ^{WDC} represents a historical wind direction cosine vector of the n^{th} wind farm on the i^{th} day, αᵢ^{WDS} represents a historical wind direction sine vector of the n^{th} wind farm on the i^{th} day, and αᵢ^{H} represents a historical humidity vector of the n^{th} wind farm on the i^{th} day; and WSᵢ^{t-1}, WSᵢ^{t-2}, . . . , WSᵢ^{t-b} represent historical wind speed vectors at moments t−1, t−2, . . . , t−b on the i^{th} day, respectively, WDCᵢ^{t-1}, WDCᵢ^{t-2}, . . . , WDCᵢ^{t-b} represent historical wind direction cosine vectors at moments t−1, t−2, . . . , t−b on the i^{th} day, respectively, WDSᵢ^{t-1}, WDSᵢ^{t-2}, . . . , WDSᵢ^{t-b} represent historical wind direction sine vectors at moments t−1, t−2, . . . , t−b on the i^{th} day, respectively, and Hᵢ^{t-1}, Hᵢ^{t-2}, . . . , Hᵢ^{t-b} represent historical humidity vectors at moments t−1, t−2, . . . , t−b on the i^{th} day.

Preferably, the converting the historical day weather feature vector set of each wind farm into a corresponding historical day Gram matrix, and using all the historical day Gram matrices to construct the sample set includes:
for the historical day weather feature vector set of each wind farm, selecting any four weather feature vectors in a European space for a pairwise inner product operation to form a corresponding historical day Gram matrix:

$${Δ}_{n}^{i} = [ \begin{matrix}〈 {a}_{i}^{W S} , {a}_{i}^{W S} 〉 & 〈 {a}_{i}^{W D C} , {a}_{i}^{W S} 〉 & 〈 {a}_{i}^{W D S} , {a}_{i}^{W S} 〉 & 〈 {a}_{i}^{H} , {a}_{i}^{W S} 〉 \\ 〈 {a}_{i}^{W S} , {a}_{i}^{W D C} 〉 & 〈 {a}_{i}^{W D C} , {a}_{i}^{W D C} 〉 & 〈 {a}_{i}^{W D S} , {a}_{i}^{W D C} 〉 & 〈 {a}_{i}^{H} , {a}_{i}^{W D C} 〉 \\ 〈 {a}_{i}^{W S} , {a}_{i}^{W D S} 〉 & 〈 {a}_{i}^{W D C} , {a}_{i}^{W D S} 〉 & 〈 {a}_{i}^{W D S} , {a}_{i}^{W D S} 〉 & 〈 {a}_{i}^{H} , {a}_{i}^{W D S} 〉 \\ 〈 {a}_{i}^{W S} , {a}_{i}^{H} 〉 & 〈 {a}_{i}^{W D C} , {a}_{i}^{H} 〉 & 〈 {a}_{i}^{W D S} , {a}_{i}^{H} 〉 & 〈 {a}_{i}^{H} , {a}_{i}^{H} 〉\end{matrix} ]$$

in the formula, Δₙⁱ represents a historical day Gram matrix of the n^{th} wind farm on the i^{th} day, and [symbol] *,* [symbol] represents the inner product operation; and
using all the historical day Gram matrices to construct a sample set:

$$Δ = \{ {Δ}_{1}^{1} , {Δ}_{1}^{2} , ... , {Δ}_{1}^{i} , ... , {Δ}_{j}^{i} , ... , {Δ}_{n}^{1} , {Δ}_{n}^{2} , ... , {Δ}_{n}^{i} \}$$

in the formula, Δ represents the sample set, Δ₁¹, Δ₁², . . . , Δ₁ⁱ represent a historical day Gram matrx of a first wind farm on the 1,2, . . . , i^{th} day, respectively, Δₙ¹, Δₙ², . . . , Δₙⁱ represent historical day Gram matrx of the nth wind farm on the 1,2, . . . , i^{th} day, respectively, and Δⱼⁱ represents a historical day Gram matrix of a j^{th} wind farm on the i^{th} day, where j=1,2, . . . , n.

Preferably, the selecting the plurality of historical day Gram matrices similar to the to-be-predicted day Gram matrices from the sample set as similar day Gram matrices by using a fuzzy C-means clustering method and a crisscross optimization algorithm includes:

S4.1: setting the number C of clustering centers, dividing the sample set Δ into C types, and taking the historical day Gram matrix Δⱼ of each wind farm as one sample in the sample set, where a number of the samples is n; and initializing a fuzzy membership matrix and a clustering center matrix;

S4.2: setting an objective function of fuzzy C-means clustering:

$$J ( U , V , Δ ) = {\sum }_{c = 1}^{C} {\sum }_{j = 1}^{n} {u}_{c j}^{m} {( {d}_{c j} ( Δ ) )}^{2}$$

in the formula, J(U, V, Δ) represents an objective function value of fuzzy C-means clustering, U represents the fuzzy membership matrix, V represents the clustering center matrix, u_{cj} represents a fuzzy membership of a j^{th} sample belonging to a c^{th} clustering center, where Σ_{c=1}^{C}u_{cj}=1 and c=1,2, . . . , C are met; m represents a fuzzy weighted index, and d_{cj}(Δ) represents a Euclidean distance between a j^{th} sample and a c^{th} clustering center;

S4.3: constructing a Lagrangian function for the objective function of fuzzy C-means clustering:

$$\tilde{J} ( U , V , Δ ) = {\sum }_{c = 1}^{C} {\sum }_{j = 1}^{n} {{u}_{c j}^{m} ( {d}_{c j} ( Δ ) )}^{2} - {\sum }_{j = 1}^{n} {α}_{j} ( {\sum }_{c = 1}^{C} {u}_{c j} - 1 )$$

in the formula, αⱼ represents a coefficient of j^{th} sample;

S4.4: deriving partial derivatives of the membership and the clustering center, respectively:

$${u}_{c j} = \frac{1}{{( {\sum }_{k = 1}^{C} ( {d}_{c j} ( Δ ) / {d}_{k j} ( Δ ) ) )}^{2 / ( m - 1 )}}$$

$${v}_{c} = \frac{{\sum }_{j = 1}^{n} {u}_{c j}^{m} {Δ}_{j}}{{\sum }_{j = 1}^{n} {u}_{c j}^{m}}$$

in the formula, dₖⱼ(Δ) represents a Euclidean distance between a j^{th} sample and a k^{th} clustering center, and v_{c} represents a c^{th} clustering center; and

S4.5: iteratively updating the fuzzy membership matrix and the clustering center matrix, repeating steps S4.2-S4.4 until a variation of the clustering center is less than a preset variation threshold, and outputting a historical day Gram matrix under the clustering center of the iteration as a similar day Gram matrix, where a calculation formula of the variation of the clustering center is: PGP-NE

$$e = ‖ {ν}_{c}^{( t )} - {ν}_{c}^{( t - 1 )} ‖$$

in the formula, e represents a variation threshold, v_{c}^{(t)} represents a c^{th} clustering center of a t^{th} iteration, v_{c}^{(t-1)} represents a c^{th} clustering center of a (t−1)^{th} iteration, and ∥*∥ represents a measure of distance.

Preferably, the calculating the corresponding similarity weight for each similar day Gram matrix according to the to-be-predicted day Gram matrices and the similar day Gram matrices, and constructing the similarity weight sequence includes:
denoting the to-be-predicted day Gram matrices as Δ^{s}, denoting a similar day Gram matrix as Δ^{l}, where Δ^{l} represents a l^{th} similar day Gram matrix, l=1,2, . . . , L, and L represents the number of similar day Gram matrices; and setting a Euclidean coupling relationship calculation formula, and calculating a similarity weight corresponding to each similar day Gram matrix:

$${w}^{l} = f ( {Δ}^{s} , {Δ}^{l} ) = \sqrt{{\sum }_{l = 1}^{L} {( {Δ}^{l} - {Δ}^{s} )}^{2}}$$

in the formula, w^{l} represents a similarity weight corresponding to a l^{th} similar day Gram matrix, and f(*) represents a Euclidean calculation formula; and
forming a similarity weight sequence w^{T}=[w¹, w², . . . , w^{l}, . . . , w^{L}] by the similarity weight corresponding to each similar day Gram matrix, where T represents a transpose operation.

Preferably, the constructed wind power prediction neural network model includes a first convolution layer, a second convolution layer, a third convolution layer, a fourth convolution layer, an extended causal convolution layer, a residual connection block, a first full connection layer, a first activation function layer, a second full connection layer, a second activation function layer, and a third full connection layer, which are sequentially connected.

Preferably, the setting the training loss function, training the constructed wind power prediction neural network model, and using the similarity weight sequence to optimize network model parameters to obtain a trained wind power prediction neural network model includes:
setting the training loss function:

$$M S E {loss}_{G} = \frac{1}{G} {\sum }_{g = 1}^{G} ( {y}_{g}^{train} - {\hat{y}}_{g}^{train} )$$

where MSEloss_{G} represents a training loss function value, G represents a number of samples in a current batch input sequence, y_{g}^{train} represents a g^{th} wind power prediction value in the current batch input sequence, and ŷ_{g}^{train} represents a g^{th} wind power target value in the current batch input sequence; and
calculating a training loss function value corresponding to the training according to the training loss function; setting an upper limit of iterative training times, and when the training times reach the upper limit of the training times, multiplying the training loss function value corresponding to each training by a similarity weight in the similarity weight sequence to obtain a weighted training loss function value; and storing the network model parameters corresponding to the minimum weighted training loss function value as the optimal network model parameters to obtain the trained wind power prediction neural network model.

Compared with the prior art, the technical solution of the present invention has the beneficial effects as follows.

The present invention provides a method for short-term wind power prediction of a newly-built wind farm based on sample migration, which consider the problems that data elimination damages the time sequence of data in the process of sample migration and that different data have different importance degrees. The method includes: firstly, pre-processing historical wind power data of the newly-built wind farm and surrounding wind farms of the newly-built wind farm to obtain a wind power related data matrix of each wind farm; then, constructing a corresponding historical day weather feature vector set according to the wind power related data matrix of each wind farm, converting the historical day weather feature vector sets into historical day Gram matrices, and using all the historical day Gram matrices to construct a sample set; then, setting a to-be-predicted day for the newly-built wind farm, selecting a plurality of historical day Gram matrices similar to the to-be-predicted day Gram matrices from the sample set as similar day Gram matrices, and endowing each similar day Gram matrix with different similar pair weights; and finally, constructing an input sequence by using historical day weather feature vectors and historical wind power corresponding to similar day Gram matrices, training a constructed wind power prediction neural network model, using a similarity weight sequence and a training loss function to optimize network model parameters to obtain a trained wind power prediction neural network model, and performing short-term wind power prediction on the newly-built wind farm to obtain a wind power prediction result. According to the present invention, the accuracy of the short-term wind power prediction of the newly-built wind farm based on the sample migration method is effectively improved, and the generalization capability is strong.

### BRIEF DESCRIPTION OF THE DRAWINGS

FIG. 1 is a flow chart of a method for short-term wind power prediction of a newly-built wind farm based on sample migration according to embodiment 1;

FIG. 2 is a schematic structural diagram of a wind power prediction neural network model according to embodiment 2;

FIG. 3 is a schematic diagram of results of prediction error values before and after a method for short-term wind power prediction of a newly-built wind farm based on sample migration is applied to an existing network model according to embodiment 2;

FIG. 4 is a schematic diagram of comparison between a predicted wind power value and an actual wind power value in a method for short-term wind power prediction of a newly-built wind farm based on sample migration according to embodiment 2; and

FIG. 5 is a schematic structural diagram of a system for short-term wind power prediction of a newly-built wind farm based on sample migration according to embodiment 3.

### DESCRIPTION OF THE EMBODIMENTS

The accompanying drawings are for exemplary illustration only and are not to be construed as limiting the patent.

For the purpose of better illustrating the present embodiments, certain components in the accompanying drawings may be omitted, enlarged or reduced, and do not represent the size of an actual product.

It will be understood by those skilled in the art that certain well-known structures in the accompanying drawings and descriptions thereof may be omitted.

The technical solution of the present invention is further described below with reference to the accompanying drawings and embodiments.

### Embodiment 1

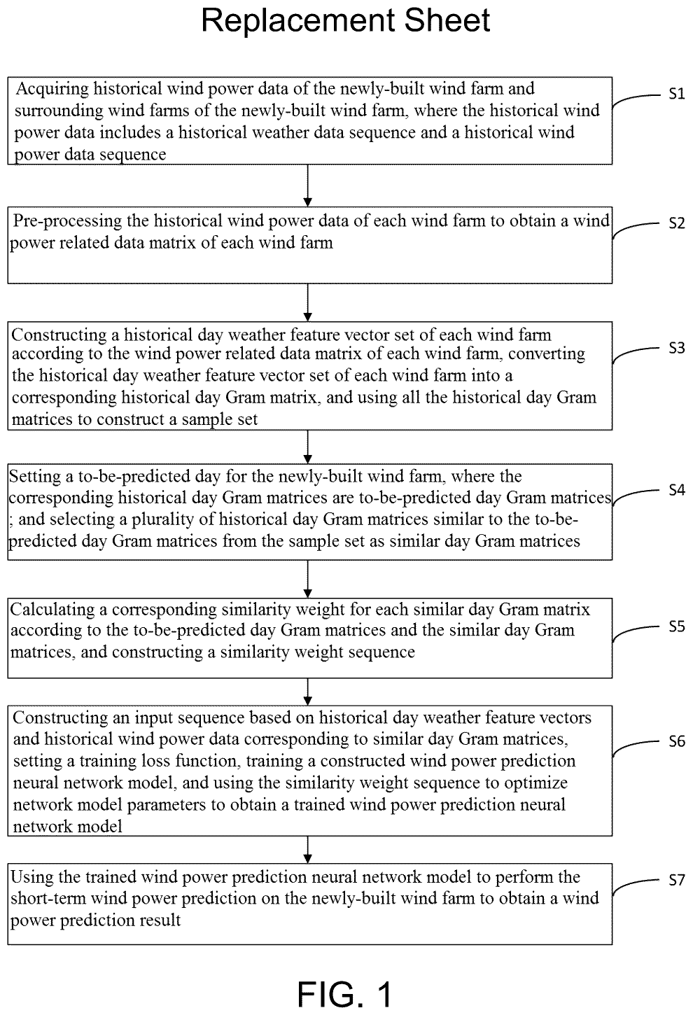

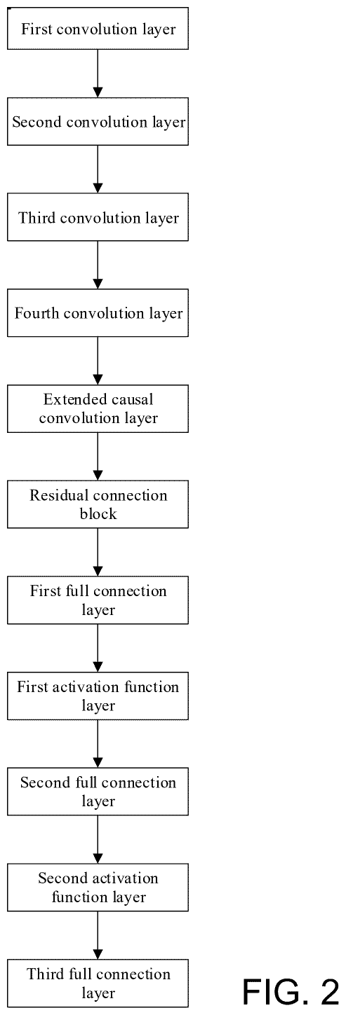

The present embodiment provides a method for short-term wind power prediction of a newly-built wind farm based on sample migration, as shown in FIG. 1, including:
S1: acquiring historical wind power data of the newly-built wind farm and surrounding wind farms of the newly-built wind farm, where the historical wind power data includes a historical weather data sequence and a historical wind power data sequence;
S2: pre-processing the historical wind power data of each wind farm to obtain a wind power related data matrix of each wind farm;
S3: constructing a historical day weather feature vector set of each wind farm according to the wind power related data matrix of each wind farm, converting the wind power related data matrix of each wind farm into a corresponding historical day Gram matrix, and using all the historical day Gram matrices to construct a sample set;
S4: setting a to-be-predicted day for the newly-built wind farm, where the corresponding historical day Gram matrices are to-be-predicted day Gram matrices; and selecting a plurality of historical day Gram matrices similar to the to-be-predicted day Gram matrices from the sample set as similar day Gram matrices;
S5: calculating a corresponding similarity weight for each similar day Gram matrix according to the to-be-predicted day Gram matrices and the similar day Gram matrices, and constructing a similarity weight sequence;
S6: constructing an input sequence based on historical day weather feature vectors and historical wind power data corresponding to similar day Gram matrices, setting a training loss function, training a constructed wind power prediction neural network model, and using the similarity weight sequence to optimize network model parameters to obtain a trained wind power prediction neural network model; and
S7: using the trained wind power prediction neural network model to perform the short-term wind power prediction on the newly-built wind farm to obtain a wind power prediction result.

In the specific implementation process, the present embodiment provides a method for short-term wind power prediction of a newly-built wind farm based on sample migration, which consider the problems that data elimination damages the time sequence of data in the process of sample migration and that different data have different importance degrees. The method includes: firstly, pre-processing historical wind power data of the newly-built wind farm and surrounding wind farms of the newly-built wind farm to obtain a wind power related data matrix of each wind farm; then, constructing a corresponding historical day weather feature vector set according to the wind power related data matrix of each wind farm, converting the historical day weather feature vector sets into historical day Gram matrices, and using all the historical day Gram matrices to construct a sample set; then, setting a to-be-predicted day for the newly-built wind farm, selecting a plurality of historical day Gram matrices similar to the to-be-predicted day Gram matrices from the sample set as similar day Gram matrices, and endowing each similar day Gram matrix with different similar pair weights; and finally, constructing an input sequence by using historical day weather feature vectors and historical wind power corresponding to similar day Gram matrices, training a constructed wind power prediction neural network model, using a similarity weight sequence and a training loss function to optimize network model parameters to obtain a trained wind power prediction neural network model, and performing short-term wind power prediction on the newly-built wind farm to obtain a wind power prediction result. According to the present embodiment, the accuracy of the short-term wind power prediction of the newly-built wind farm based on the sample migration method is effectively improved, and the generalization capability is strong.

### Embodiment 2

The present embodiment provides a method for short-term wind power prediction of a newly-built wind farm based on sample migration, including:
S1: acquiring historical wind power data of the newly-built wind farm and surrounding wind farms of the newly-built wind farm, where the historical wind power data includes a historical weather data sequence and a historical wind power data sequence; and the historical weather data sequence includes a historical wind speed data sequence, a historical wind direction data sequence, and a historical humidity data sequence;
S2: pre-processing the historical wind power data of each wind farm to obtain a wind power related data matrix of each wind farm, which includes:
performing min-max normalization processing on the historical wind speed data sequence, the historical wind direction data sequence, the historical humidity data sequence and the historical wind power data sequence of each wind farm to obtain processed historical wind speed data, historical wind direction data, historical humidity data and historical wind power data;
performing sine-cosine processing on the processed historical wind direction data to obtain processed historical wind direction sine data and historical wind direction cosine data; and
using the processed historical wind speed data, historical wind direction sine data, historical wind direction cosine data, historical humidity data and historical wind power data of each wind farm to construct a wind power related data matrix of the wind farm:

$${X}_{n} = [ \begin{matrix}{P}_{T}^{t - 1} & W {S}_{T}^{t - 1} & W D {C}_{T}^{t - 1} & W D {S}_{T}^{t - 1} & {H}_{T}^{t - 1} \\ {P}_{T}^{t - 2} & W {S}_{T}^{t - 2} & W D {C}_{T}^{t - 2} & W D {S}_{T}^{t - 2} & {H}_{T}^{t - 2} \\ ⋮ & ⋮ & ⋮ & ⋮ & ⋮ \\ {P}_{T}^{t - b} & W {S}_{T}^{t - b} & W D {C}_{T}^{t - b} & W D {S}_{T}^{t - b} & {H}_{T}^{t - b}\end{matrix} ]$$

in the formula, Xₙ represents a wind power related data matrix of an n^{th} wind farm, P_{T}^{t-1}, P_{T}^{t-2}, . . . , P_{T}^{t-b} represent processed historical wind powers of the n^{th} wind farm at moments t−1, t−2, . . . , t−b, respectively, WS_{T}^{t-1}, WS_{T}^{t-2}, . . . , WS_{T}^{t-b} represent processed historical wind speeds of the n^{th} wind farm at moments t−1, t−2, . . . , t−b, respectively, WDC_{T}^{t-1}, WDC_{T}^{t-2}, . . . , WDC_{T}^{t-b} represent processed historical wind direction cosines of the n^{th} wind farm at moments t−1, t−2, . . . , t−b, respectively, WDS_{T}^{t-1}, WDS_{T}^{t-2}, . . . , WDS_{T}^{t-b} represent historical wind direction sines of the n^{th} wind farm at moments t−1, t−2, . . . , t−b, respectively, H_{T}^{t-1}, H_{T}^{t-2}, . . . , H_{T}^{t-b} represent processed historical humidities of the n^{th} wind farm at moments t−1, t−2, . . . , t−b, respectively, and T represents a total moment;
S3: constructing a historical day weather feature vector set of each wind farm according to the wind power related data matrix of each wind farm, converting the historical day weather feature vector set of each wind farm into a corresponding historical day Gram matrix, and using all the historical day Gram matrices to construct a sample set, which includes:
obtaining daily wind power related data of each wind farm from the wind power related data matrix of each wind farm to form the historical day weather feature vector set of each wind farm:

$${D}_{n}^{i} = [ \begin{matrix}{a}_{i}^{W S} \\ {a}_{i}^{W D C} \\ {a}_{i}^{W D S} \\ {a}_{i}^{H}\end{matrix} ] = [ \begin{matrix}W {S}_{i}^{t - 1} & W {S}_{i}^{t - 2} & ⋯ & W {S}_{i}^{t - b} \\ W D {C}_{i}^{t - 1} & W D {C}_{i}^{t - 2} & ⋯ & W D {C}_{i}^{t - b} \\ W D {S}_{i}^{t - 1} & W D {S}_{i}^{t - 2} & ⋯ & W D {S}_{i}^{t - b} \\ {H}_{i}^{t - 1} & {H}_{i}^{t - 2} & ⋯ & {H}_{i}^{t - b}\end{matrix} ]$$

in the formula, Dₙⁱ represents a historical day weather feature vector set of a n^{th} wind farm on an i^{th} day, αᵢ^{WS} represents a historical wind speed vector of the n^{th} wind farm on the i^{th} day, αᵢ^{WDC} represents a historical wind direction cosine vector of the n^{th} wind farm on the i^{th} day, αᵢ^{WDS} represents a historical wind direction sine vector of the n^{th} wind farm on the i^{th} day, and αᵢ^{H} represents a historical humidity vector of the n^{th} wind farm on the i^{th} day; and WSᵢ^{t-1}, WSᵢ^{t-2}, . . . , WSᵢ^{t-b} represent historical wind speed vectors at moments t−1, t−2, . . . , t−b on the i^{th} day, respectively, WDCᵢ^{t-1}, WDCᵢ^{t-2}, . . . , WDCᵢ^{t-b} represent historical wind direction cosine vectors at moments t−1, t−2, . . . , t−b on the i^{th} day, respectively, WDSᵢ^{t-1}, WDSᵢ^{t-2}, . . . , WDSᵢ^{t-b} represent historical wind direction sine vectors at moments t−1, t−2, . . . , t−b on the i^{th} day, respectively, and Hᵢ^{t-1}, Hᵢ^{t-2}, . . . , Hᵢ^{t-b} represent historical humidity vectors at moments t−1, t−2, . . . , t−b on the i^{th} day;
for the historical day weather feature vector set of each wind farm, selecting any four weather feature vectors in a European space for a pairwise inner product operation to form a corresponding historical day Gram matrix:

$${Δ}_{n}^{i} = [ \begin{matrix}〈 {a}_{i}^{W S} , {a}_{i}^{W S} 〉 & 〈 {a}_{i}^{W D C} , {a}_{i}^{W S} 〉 & 〈 {a}_{i}^{W D S} , {a}_{i}^{W S} 〉 & 〈 {a}_{i}^{H} , {a}_{i}^{W S} 〉 \\ 〈 {a}_{i}^{W S} , {a}_{i}^{W D C} 〉 & 〈 {a}_{i}^{W D C} , {a}_{i}^{W D C} 〉 & 〈 {a}_{i}^{W D S} , {a}_{i}^{W D C} 〉 & 〈 {a}_{i}^{H} , {a}_{i}^{W D C} 〉 \\ 〈 {a}_{i}^{W S} , {a}_{i}^{W D S} 〉 & 〈 {a}_{i}^{W D C} , {a}_{i}^{W D S} 〉 & 〈 {a}_{i}^{W D S} , {a}_{i}^{W D S} 〉 & 〈 {a}_{i}^{H} , {a}_{i}^{W D S} 〉 \\ 〈 {a}_{i}^{W S} , {a}_{i}^{H} 〉 & 〈 {a}_{i}^{W D C} , {a}_{i}^{H} 〉 & 〈 {a}_{i}^{W D S} , {a}_{i}^{H} 〉 & 〈 {a}_{i}^{H} , {a}_{i}^{H} 〉\end{matrix} ]$$

in the formula, Δₙⁱ represents a historical day Gram matrix of the n^{th} wind farm on the i^{th} day, and [symbol] *,* [symbol] represents the inner product operation; and
using all the historical day Gram matrices to construct a sample set:

Δ={Δ₁¹, Δ₁², . . . , Δ₁ⁱ, . . . , Δⱼⁱ, . . . , Δₙ¹, Δₙ², . . . , Δₙⁱ}
in the formula, Δ represents the sample set, Δ₁¹, Δ₁², . . . , Δ₁ⁱ represent a historical day Gram matrx of a first wind farm on the 1,2, . . . , i^{th} day, respectively, Δₙ¹, Δₙ², . . . , Δₙⁱ represent historical day Gram matrx of the nth wind farm on the 1,2, . . . , i^{th} day, respectively, and Δⱼⁱ represents a historical day Gram matrix of a j^{th} wind farm on the i^{th} day, where j=1,2, . . . , n;
S4: setting a to-be-predicted day for the newly-built wind farm, where the corresponding historical day Gram matrices are to-be-predicted day Gram matrices;
and selecting a plurality of historical day Gram matrices similar to the to-be-predicted day Gram matrices from the sample set as similar day Gram matrices by using a fuzzy C-means clustering method and a crisscross optimization algorithm, which includes;

S4.1: setting the number C of clustering centers, dividing the sample set Δ into C types, and taking the historical day Gram matrix Δⱼ of each wind farm as one sample in the sample set, where the number of the samples is n; and initializing a fuzzy membership matrix and a clustering center matrix;
S4.2: setting an objective function of fuzzy C-means clustering:

$$J ( U , V , Δ ) = {\sum }_{c = 1}^{C} {\sum }_{j = 1}^{n} {u}_{c j}^{m} {( {d}_{c j} ( Δ ) )}^{2}$$

in the formula, J(U, V, Δ) represents an objective function value of fuzzy C-means clustering, U represents the fuzzy membership matrix, V represents the clustering center matrix, u_{cj} represents a fuzzy membership of a j^{th} sample belonging to a c^{th} clustering center, where Σ_{c=1}^{C}u_{cj}=1, and c=1,2, . . . , C are met; m represents a fuzzy weighted index, and d_{cj}(Δ) represents a Euclidean distance between a j^{th} sample and a c^{th} clustering center;
S4.3: constructing a Lagrangian function for the objective function of fuzzy C-means clustering:

$$\tilde{J} ( U , V , Δ ) = {\sum }_{c = 1}^{C} {\sum }_{j = 1}^{n} {u}_{c j}^{m} {( {d}_{c j} ( Δ ) )}^{2} - {\sum }_{j = 1}^{n} {α}_{j} ( {\sum }_{c = 1}^{C} {u}_{c j} - 1 )$$

in the formula, αⱼ represents a coefficient of a j^{th} sample;
S4.4: deriving partial derivatives of the membership and the clustering center, respectively:

$${u}_{c j} = \frac{1}{{( {\sum }_{k = 1}^{C} ( {d}_{c j} ( Δ ) / {d}_{k j} ( Δ ) ) )}^{2 / ( m - 1 )}}$$

$${v}_{c} = \frac{{\sum }_{j = 1}^{n} {u}_{c j}^{m} {Δ}_{j}}{{\sum }_{j = 1}^{n} {u}_{c j}^{m}}$$

in the formula, dₖⱼ(Δ) represents a Euclidean distance between a j^{th} sample and a k^{th} clustering center, and v_{c} represents a c^{th} clustering center; and
S4.5: iteratively updating the fuzzy membership matrix and the clustering center matrix, repeating steps S44.22-S44.44 until a variation of the clustering center is less than a preset variation threshold, and outputting a historical day Gram matrix under the clustering center of the iteration as a similar day Gram matrix, where a calculation formula of the variation of the clustering center is:

$$e = ‖ {v}_{c}^{( t )} - {v}_{c}^{( t - 1 )} ‖$$

in the formula, e represents a variation threshold, v_{c}^{(t)} represents a c^{th} clustering center of a t^{th} iteration, v_{c}^{(t-1)} represents a c^{th} clustering center of a (t−1)^{th} iteration, and ∥*∥ represents a measure of distance;
S5: calculating a corresponding similarity weight for each similar day Gram matrix according to the to-be-predicted day Gram matrices and the similar day Gram matrices, and constructing a similarity weight sequence, which includes;
denoting the to-be-predicted day Gram matrices as Δ^{s}, denoting a similar day Gram matrix as Δ^{l}, where Δ^{l} represents a l^{th} similar day Gram matrix, l=1,2, . . . , L, and L represents the number of similar day Gram matrices; and setting a Euclidean coupling relationship calculation formula, and calculating a similarity weight corresponding to each similar day Gram matrix:

$${w}^{l} = f ( {Δ}^{s} , {Δ}^{l} ) = \sqrt{{\sum }_{l = 1}^{L} {( {Δ}^{l} - {Δ}^{s} )}^{2}}$$

in the formula, w^{l} represents a similarity weight corresponding to a l^{th} similar day Gram matrix, and f(*) represents a Euclidean calculation formula; and
forming a similarity weight sequence w^{T}=[w¹, w², . . . , w^{l}, . . . , w^{L}] by the similarity weight corresponding to each similar day Gram matrix, where T represents a transpose operation;
S6: constructing an input sequence based on historical day weather feature vectors and historical wind power corresponding to similar day Gram matrices, setting a training loss function, training a constructed wind power prediction neural network model, and using the similarity weight sequence to optimize network model parameters to obtain a trained wind power prediction neural network model; and
performing feature tensor processing on the historical day weather feature vector and the historical wind power corresponding to the similar day Gram matrix to construct an input sequence:

$${X}_{INPUT} = [ \begin{matrix}{x}_{WPi}^{T - b} & {x}_{WSi}^{T - b} & {x}_{WDSi}^{T - b} & {x}_{WDCi}^{T - b} \\ ⋮ & ⋮ & ⋮ & ⋮ \\ {x}_{WPi}^{T - b} & {x}_{WSi}^{T - b} & {x}_{WDSi}^{T - b} & {x}_{WDCi}^{T - b}\end{matrix} ]$$

in the formula, X_{INPUT} represents the input sequence, x_{WPi}^{T-1}, x_{WPi}^{T-b} represent wind power features at moments (T−1)^{th}, (T−b)^{th} in the i^{th} hour in a tensor, respectively, x_{WSi}^{T-1}, x_{WSi}^{T-b} represent wind speed features at moments (T−1)^{th}, (T−b)^{th} in the i^{th} hour in the tensor, respectively, x_{WPi}^{T-1}, x_{WPi}^{T-b} represent wind direction sine features at moments (T−1)^{th}, (T−b)^{th} in the i^{th} hour in the tensor, respectively, and x_{WDCi}^{T-1}, x_{WDCi}^{T-b} represent wind direction cosine features at moments (T−1)^{th}, (T−b)^{th} in the i^{th} hour in the tensor, respectively;
as shown in FIG. 22, the constructed wind power prediction neural network model includes a first convolution layer, a second convolution layer, a third convolution layer, a fourth convolution layer, an extended causal convolution layer, a residual connection block, a first full connection layer, a first activation function layer, a second full connection layer, a second activation function layer, and a third full connection layer, which are sequentially connected;
setting the training loss function:

$${MSEloss}_{G} = \frac{1}{G} {\sum }_{g = 1}^{G} ( {y}_{g}^{train} - {\hat{y}}_{g}^{train} )$$

where MSEloss_{G} represents a training loss function value, G represents the number of samples in a current batch input sequence, y_{g}^{train} represents a g^{th} wind power prediction value in the current batch input sequence, and ŷ_{g}^{train} represents a g^{th} wind power target value in the current batch input sequence; and
calculating a training loss function value corresponding to the training according to the training loss function; setting an upper limit of iterative training times, and when the training times reach the upper limit of the training times, multiplying the training loss function value corresponding to each training by a similarity weight in the similarity weight sequence to obtain a weighted training loss function value; and storing the network model parameters corresponding to a minimum weighted training loss function value as the optimal network model parameters to obtain the trained wind power prediction neural network model; and
S7: using the trained wind power prediction neural network model to perform the short-term wind power prediction on the newly-built wind farm to obtain a wind power prediction result.

Before step S4.1, determining, by using the crisscross optimization algorithm, optimal hyper-parameters including the number C of clustering centers and fuzzy weighted indexes m, which includes:
1) setting a particle swarm size of the crisscross optimization algorithm as P, and initializing the number of clustering centers and the fuzzy weighted indexes; and serving P groups of randomly initialized hyper-parameter sequences K=[C, m] as a parental generation of a population and each randomly initialized hyper-parameter as a population particle;
2) determining a fitness function of the particle swarm and searching for an optimal particle swarm;
3) establishing a horizontal crossover algorithm, serving P groups of randomly initialized parameters as a parental generation of a population, and before each iteration, performing pairwise pairing on parental-generation hyper-parameters K to generate a sub-generation hyper-parameter sequence K:

$$\{ \begin{matrix}\tilde{K} ( i ) = {r}_{1} \cdot K ( i ) + ( 1 - {r}_{1} ) \cdot K ( j ) + {c}_{1} \cdot ( K ( i ) - K ( j ) ) \\ \tilde{K} ( j ) = {r}_{2} \cdot K ( j ) + ( 1 - {r}_{2} ) \cdot K ( i ) + {c}_{2} \cdot ( K ( j ) - K ( i ) )\end{matrix}$$

the formula, K(i), K(j) represent a i^{th} group and a j^{th} group of parental-generation hyper-parameter sequences paired in pairs, respectively, and r₁, r₂, c₁, c₂ represent the first, second, third and fourth random numbers, respectively, where r₁, r₂∈[0,1], and c₁, c₂∈[−1,1];
4) establishing a vertical crossover algorithm, serving P groups of randomly initialized parameters as a parental generation of a population, and performing pairwise pairing on hyper-parameters in any one of the parental-generation hyper-parameter sequences to generate a sub-generation clustering center and a sub-generation fuzzy weighed index:

$$\begin{matrix}{C}^{′} = r \cdot C + ( 1 - r ) \cdot m \\ {m}^{′} = r \cdot m + ( 1 - r ) \cdot C\end{matrix}$$

in the formula, C′ represents the sub-generation clustering center, m′ represents m′, and r represents the fifth random number, where r∈[0,1];
5) updating P groups of parental-generation self-parameter sequences by using a crisscross optimization algorithm to obtain P groups of sub-generation hyper-parameter sequences, where a horizontal crossover probability is set to θ_{c}, and a vertical crossover probability is set to θₕ;
6) applying the P group of parental-generation hyper-parameters and the P group of sub-generation hyper-parameters in turn, and using the obtained hyper-parameters for network parameter training; and after the training is completed, calculating the corresponding particle fitness according to a fitness function formula, where the sub-generation with the fitness superior to that of the parental-generation enters the next generation, and the size P of the population is maintained; and
7) repeating step 6) until the iteration of the crisscross optimization algorithm is completed, so as to obtain a clustering number and a fuzzy weighted index with the optimal fitness as optimal hyper-parameters.

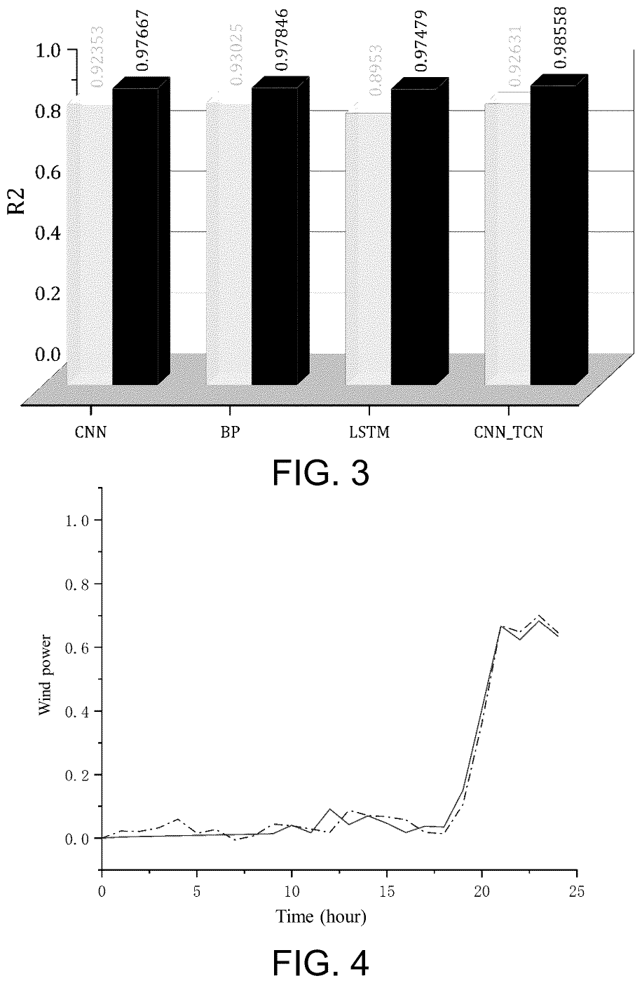

In the specific implementation process, the short-term wind power prediction of a newly-built wind farm is performed for one hour in the next day, and an existing CNN model, a BP network model, an LSTM network model and a CNN-TCN network model serve as a wind power prediction neural network model, the prediction error values before and after the application of the method for the short-term wind power prediction of the newly-built wind farm based on sample migration provided in the present embodiment are compared, and the comparison result is shown in FIG. 3, where the vertical axis R2 represents the prediction error value, and the closer to 1, the smaller the error is; a light color histogram represents a prediction error value when the sample migration is directly performed, and a dark color histogram represents a prediction error value when the method of the present embodiment is applied, and therefore, it can be seen that when the method of the present embodiment is applied to the existing network model, the prediction error values are reduced, so that the prediction accuracy is improved; as shown in FIG. 4 that is a comparison chart of a predicted wind power value and an actual wind power value according to the method provided in the present embodiment, the solid line represents the actual wind power value and the dotted line represents the predicted wind power value; and therefore, it can be seen that the predicted wind power value is very close to the actual wind power value, which indicates that the method provided in the present embodiment has a good fitting effect and high prediction accuracy.

### Embodiment 3

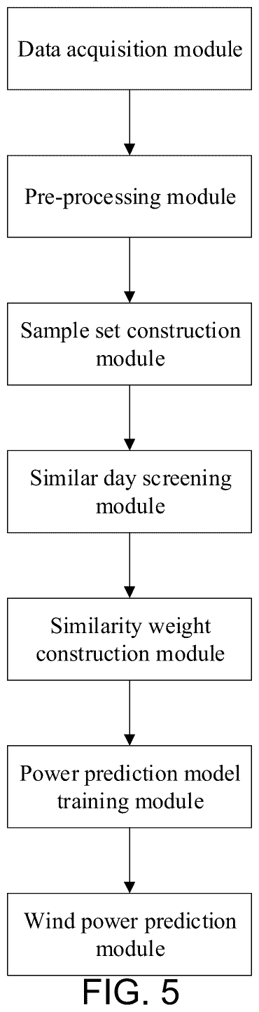

The present invention further provides a system for short-term wind power prediction of a newly-built wind farm based on sample migration for implementing the method of the embodiment 1 or the embodiment 2, as shown in FIG. 5, including:
a data acquisition module, configured to acquire historical wind power data of the newly-built wind farm and surrounding wind farms of the newly-built wind farm, where the historical wind power data includes a historical weather data sequence and a historical wind power data sequence;
a pre-processing module, configured to pre-process the historical wind power data of each wind farm to obtain a wind power related data matrix of each wind farm;
a sample set construction module, configured to construct a historical day weather feature vector set of each wind farm according to the wind power related data matrix of each wind farm, to convert the wind power related data matrix of each wind farm into a corresponding historical day Gram matrix, and to use all the historical day Gram matrices to construct a sample set;
a similar day screening module, configured to set a to-be-predicted day for the newly-built wind farm, where the corresponding historical day Gram matrices are to-be-predicted day Gram matrices; and to select a plurality of historical day Gram matrices similar to the to-be-predicted day Gram matrices from the sample set as similar day Gram matrices;
a similarity weight construction module, configured to calculate a corresponding similarity weight for each similar day Gram matrix according to the to-be-predicted day Gram matrices and the similar day Gram matrices, and to construct a similarity weight sequence;
a power prediction model training module, configured to construct an input sequence based on historical day weather feature vectors and historical wind power data corresponding to similar day Gram matrices, to set a training loss function, to train a constructed wind power prediction neural network model, and to use the similarity weight sequence to optimize network model parameters to obtain a trained wind power prediction neural network model; and
a wind power prediction module, configured to use the trained wind power prediction neural network model to perform the short-term wind power prediction on the newly-built wind farm to obtain a wind power prediction result.

The same or similar reference numbers correspond to the same or similar components.

The terms describing the positional relationships in the accompanying drawings are for exemplary illustration only and are not to be construed as limiting the scope of the patent.

Obviously, the above embodiments of the present invention are merely examples for clearly illustrating the present invention, and are not intended to limit the embodiments of the present invention. For ordinary technicians in the art, other changes or variations in different forms may be made on the basis of the above description. All the embodiments are not required and are not exhaustive here. All modifications, equivalents, improvements, etc., which are within the spirit and principles of the present invention, are intended to be included within the scope of protection of claims of the present invention.

What is claimed is:

1. A method for short-term wind power prediction of a newly-built wind farm based on sample migration, comprising:
S1: acquiring historical wind power data of the newly-built wind farm and surrounding wind farms of the newly-built wind farm, where the historical wind power data comprises a historical weather data sequence and a historical wind power data sequence;
S2: pre-processing the historical wind power data of each of the wind farms to obtain a wind power related data matrix of each of the wind farms;
S3: constructing a historical day weather feature vector set of each of the wind farms according to the wind power related data matrix of each of the wind farms, converting the historical day weather feature vector set of each of the wind farms into a corresponding historical day Gram matrix, and using all historical day Gram matrices to construct a sample set;
S4: setting a to-be-predicted day for the newly-built wind farm, where corresponding historical day Gram matrices are to-be-predicted day Gram matrices; and selecting a plurality of the historical day Gram matrices similar to the to-be-predicted day Gram matrices from the sample set as similar day Gram matrices;
S5: calculating a corresponding similarity weight for each of the similar day Gram matrices according to the to-be-predicted day Gram matrices and the similar day Gram matrices, and constructing a similarity weight sequence;
S6: constructing an input sequence based on historical day weather feature vectors and historical wind power data corresponding to the similar day Gram matrices, setting a training loss function, training a constructed wind power prediction neural network model, and using the similarity weight sequence to optimize network model parameters to obtain a trained wind power prediction neural network model; and
S7: using the trained wind power prediction neural network model to perform the short-term wind power prediction on the newly-built wind farm to obtain a wind power prediction result.

2. The method for the short-term wind power prediction of the newly-built wind farm based on sample migration according to claim 1, wherein the historical weather data sequence comprises a historical wind speed data sequence, a historical wind direction data sequence, and a historical humidity data sequence.

3. The method for the short-term wind power prediction of the newly-built wind farm based on sample migration according to claim 2, wherein the pre-processing the historical wind power data of each of the wind farms to obtain the wind power related data matrix of each of the wind farms comprises:
performing min-max normalization processing on the historical wind speed data sequence, the historical wind direction data sequence, the historical humidity data sequence and the historical wind power data sequence of each of the wind farms to obtain processed historical wind speed data, historical wind direction data, historical humidity data and the historical wind power data;
performing sine-cosine processing on processed historical wind direction data to obtain processed historical wind direction sine data and historical wind direction cosine data; and
using the processed historical wind speed data, the processed historical wind direction sine data, the historical wind direction cosine data, the historical humidity data and the historical wind power data of each of the wind farms to construct the wind power related data matrix of the wind farms:
$${X}_{n} = [ \begin{matrix}{P}_{T}^{t - 1} & {WS}_{T}^{t - 1} & {WDC}_{T}^{t - 1} & {WDS}_{T}^{t - 1} & {H}_{T}^{t - 1} \\ {P}_{T}^{t - 2} & {WS}_{T}^{t - 2} & {WDC}_{T}^{t - 2} & {WDS}_{T}^{t - 2} & {H}_{T}^{t - 2} \\ ⋮ & ⋮ & ⋮ & ⋮ & ⋮ \\ {P}_{T}^{t - b} & {WS}_{T}^{t - b} & {WDC}_{T}^{t - b} & {WDS}_{T}^{t - b} & {H}_{T}^{t - b}\end{matrix} ]$$
in above formula, Xₙ represents a wind power related data matrix of an n^{th} wind farm, P_{T}^{t-1}, P_{T}^{t-2}, . . . , P_{T}^{t-b} represent processed historical wind powers of the n^{th} wind farm at moments t−1, t−2, . . . , t−b, respectively, WS_{T}^{t-1}, WS_{T}^{t-2}, . . . , WS_{T}^{t-b} represent processed historical wind speeds of the n^{th} wind farm at moments t−1, t−2, . . . , t−b, respectively, WDC_{T}^{t-1}, WDC_{T}^{t-2}, . . . , WDC_{T}^{t-b} represent processed historical wind direction cosines of the n^{th} wind farm at moments t−1, t−2, . . . , t−b, respectively, WDS_{T}^{t-1}, WDS_{T}^{t-2}, . . . , WDS_{T}^{t-b} represent historical wind direction sines of the n^{th} wind farm at moments t−1, t−2, . . . , t−b, respectively, H_{T}^{t-1}, H_{T}^{t-2}, . . . , H_{T}^{t-b} represent processed historical humidities of the n^{th} wind farm at moments t−1, t−2, . . . , t−b, respectively, and T represents a total moment.

4. The method for the short-term wind power prediction of the newly-built wind farm based on sample migration according to claim 3, wherein the constructing the historical day weather feature vector set of each of the wind farms according to the wind power related data matrix of each of the wind farms comprises:
obtaining daily wind power related data of each of the wind farms from the wind power related data matrix of each of the wind farms to form the historical day weather feature vector set of each of the wind farms:
$${D}_{n}^{i} = [ \begin{matrix}{a}_{i}^{WS} \\ {a}_{i}^{WDC} \\ {a}_{i}^{WDS} \\ {a}_{i}^{H}\end{matrix} ] = [ \begin{matrix}{WS}_{i}^{t - 1} & {WS}_{i}^{t - 2} & ⋯ & {WS}_{i}^{t - b} \\ {WDC}_{i}^{t - 1} & {WDC}_{i}^{t - 2} & ⋯ & {WDC}_{i}^{t - b} \\ {WDS}_{i}^{t - 1} & {WDS}_{i}^{t - 2} & ⋯ & {WDS}_{i}^{t - b} \\ {H}_{i}^{t - 1} & {H}_{i}^{t - 2} & ⋯ & {H}_{i}^{t - b}\end{matrix} ]$$
in the formula, Dₙⁱ represents a historical day weather feature vector set of a n^{th} wind farm on an i^{th} day, αᵢ^{WS} represents a historical wind speed vector of the n^{th} wind farm on the i^{th} day, αᵢ^{WDC} represents a historical wind direction cosine vector of the n^{th} wind farm on the i^{th} day, αᵢ^{WDS} represents a historical wind direction sine vector of the n^{th} wind farm on the i^{th} day, and αᵢ^{H} represents a historical humidity vector of the n^{th} wind farm on the i^{th} day; and WSᵢ^{t-1}, WSᵢ^{t-2}, . . . , WSᵢ^{t-b} represent historical wind speed vectors at moments t−1, t−2, . . . , t−b on the i^{th} day, respectively, WDCᵢ^{t-1}, WDCᵢ^{t-2}, . . . , WDCᵢ^{t-b} represent historical wind direction cosine vectors at moments t−1, t−2, . . . , t−b on the i^{th} day, respectively, WDSᵢ^{t-1}, WDSᵢ^{t-2}, . . . , WDSᵢ^{t-b} represent historical wind direction sine vectors at moments t−1, t−2, . . . , t−b on the i^{th} day, respectively, and Hᵢ^{t-1}, Hᵢ^{t-2}, . . . , Hᵢ^{t-b} represent historical humidity vectors at moments t−1, t−2, . . . , t−b on the i^{th} day.

5. The method for the short-term wind power prediction of the newly-built wind farm based on sample migration according to claim 4, wherein the converting the historical day weather feature vector set of each of the wind farms into the corresponding historical day Gram matrix, and using all the historical day Gram matrices to construct the sample set comprises:
for the historical day weather feature vector set of each of the wind farms, selecting any four weather feature vectors in a European space for a pairwise inner product operation to form the corresponding historical day Gram matrix:
$${Δ}_{n}^{i} = [ \begin{matrix}〈 {a}_{i}^{WS} , {a}_{i}^{WS} 〉 & 〈 {a}_{i}^{WDC} , {a}_{i}^{WS} 〉 & 〈 {a}_{i}^{WDS} , {a}_{i}^{WS} 〉 & 〈 {a}_{i}^{H} , {a}_{i}^{WS} 〉 \\ 〈 {a}_{i}^{WS} , {a}_{i}^{WDC} 〉 & 〈 {a}_{i}^{WDC} , {a}_{i}^{WDC} 〉 & 〈 {a}_{i}^{WDS} , {a}_{i}^{WDC} 〉 & 〈 {a}_{i}^{H} , {a}_{i}^{WDC} 〉 \\ 〈 {a}_{i}^{WS} , {a}_{i}^{WDS} 〉 & 〈 {a}_{i}^{WDC} , {a}_{i}^{WDS} 〉 & 〈 {a}_{i}^{WDS} , {a}_{i}^{WDS} 〉 & 〈 {a}_{i}^{H} , {a}_{i}^{WDS} 〉 \\ 〈 {a}_{i}^{WS} , {a}_{i}^{H} 〉 & 〈 {a}_{i}^{WDC} , {a}_{i}^{H} 〉 & 〈 {a}_{i}^{WDS} , {a}_{i}^{H} 〉 & 〈 {a}_{i}^{H} , {a}_{i}^{H} 〉\end{matrix} ]$$
in the formula, Δₙⁱ represents a historical day Gram matrix of the n^{th} wind farm on the i^{th} day, and [symbol] *,* [symbol] represents the inner product operation; and
using all the historical day Gram matrices to construct the sample set:
Δ={Δ₁¹, Δ₁², . . . , Δ₁ⁱ, . . . , Δⱼⁱ, . . . , Δₙ¹, Δₙ², . . . , Δₙⁱ}
in the formula, Δ represents the sample set, Δ₁¹, Δ₁², . . . , Δ₁ⁱ represent a historical day Gram matrx of a first wind farm on the 1,2, . . . , i^{th} day, respectively, Δₙ¹, Δₙ², . . . , Δₙⁱ represent a historical day Gram matrx of the n^{th} wind farm on the 1,2, . . . , i^{th} day, respectively, and Δⱼⁱ represents a historical day Gram matrix of a j^{th} wind farm on the i^{th} day, wherein j=1,2, . . . , n.

6. The method for the short-term wind power prediction of the newly-built wind farm based on sample migration according to claim 5, wherein the selecting the plurality of historical day Gram matrices similar to the to-be-predicted day Gram matrices from the sample set as the similar day Gram matrices by using a fuzzy C-means clustering method and a crisscross optimization algorithm comprises:
S4.1: setting a number C of clustering centers, dividing the sample set Δ into C types, and taking the historical day Gram matrix Δⱼ of each of the wind farms as one sample in the sample set, where a number of the samples is n; and initializing a fuzzy membership matrix and a clustering center matrix;
S4.2: setting an objective function of fuzzy C-means clustering:
$$J ( U , V , Δ ) = {\sum }_{c = 1}^{C} {\sum }_{j = 1}^{n} {{u}_{cj}^{m} ( {d}_{cj} ( Δ ) )}^{2}$$
in the formula, J(U, V, Δ) represents an objective function value of fuzzy C-means clustering, U represents the fuzzy membership matrix, V represents the clustering center matrix, u_{cj} represents a fuzzy membership of a j^{th} sample belonging to a c^{th} clustering center, where Σ_{c=1}^{C}u_{cj}=1 and c=1,2, . . . , C; m represents a fuzzy weighted index, and d_{cj}(Δ) represents a Euclidean distance between a j^{th} sample and a c^{th} clustering center;
S4.3: constructing a Lagrangian function for the objective function of fuzzy C-means clustering:
$$\tilde{J} ( U , V , Δ ) = {\sum }_{c = 1}^{C} {\sum }_{j = 1}^{n} {{u}_{cj}^{m} ( {d}_{cj} ( Δ ) )}^{2} - {\sum }_{j = 1}^{n} {α}_{j} ( {\sum }_{c = 1}^{C} {u}_{cj} - 1 )$$
in the formula, αⱼ represents a coefficient of a j^{th} sample;
S4.4: deriving partial derivatives of the membership and the clustering center, respectively:
$${u}_{cj} = \frac{1}{{( {\sum }_{k = 1}^{C} ( {d}_{cj} ( Δ ) / {d}_{kj} ( Δ ) ) )}^{2 / ( m - 1 )}}$$
$${v}_{c} = \frac{{\sum }_{j = 1}^{n} {u}_{cj}^{m} {Δ}_{j}}{{\sum }_{j = 1}^{n} {u}_{cj}^{m}}$$
in the formula, dₖⱼ(Δ) represents a Euclidean distance between a j^{th} sample and a k^{th} clustering center, and v_{c} represents a c^{th} clustering center; and
S4.5: iteratively updating the fuzzy membership matrix and the clustering center matrix, repeating steps S4.2-S4.4 until a variation of the clustering center is less than a preset variation threshold, and outputting a historical day Gram matrix under the clustering center of the iteration as a similar day Gram matrix, where a calculation formula of the variation of the clustering center is:
$$e = ‖ {v}_{c}^{( t )} - {v}_{c}^{( t - 1 )} ‖$$
in the formula, e represents a variation threshold, v_{c}^{(t)} represents a c^{th} clustering center of a t^{th} iteration, v_{c}^{(t-1)} represents a c^{th} clustering center of a (t−1)^{th} iteration, and ∥*∥ represents a measure of distance.

7. The method for the short-term wind power prediction of the newly-built wind farm based on sample migration according to claim 1, wherein the calculating the corresponding similarity weight for each of the similar day Gram matrices according to the to-be-predicted day Gram matrices and the similar day Gram matrices, and constructing the similarity weight sequence comprises:
denoting the to-be-predicted day Gram matrices as Δ^{s}, denoting a similar day Gram matrix as Δ^{l}, where Δₗ represents a l^{th} similar day Gram matrix, l=1,2, . . . , L, and L represents the number of the similar day Gram matrices; and setting a Euclidean coupling relationship calculation formula, and calculating a similarity weight corresponding to each of the similar day Gram matrices:
$${w}^{l} = f ( {Δ}^{s} , {Δ}^{l} ) = \sqrt{{\sum }_{l = 1}^{L} {( {Δ}^{l} - {Δ}^{s} )}^{2}}$$
in the formula, w^{l} represents a similarity weight corresponding to a l^{th} similar day Gram matrix, and f(*) represents the Euclidean coupling relationship calculation formula; and
forming a similarity weigh sequence w^{T}=[w¹, w², . . . , w^{l}, . . . , w^{L}] by the similarity weight corresponding to each of the similar day Gram matrices, where T represents a transpose operation.

8. The method for the short-term wind power prediction of the newly-built wind farm based on sample migration according to claim 1, wherein the constructed wind power prediction neural network model comprises a first convolution layer, a second convolution layer, a third convolution layer, a fourth convolution layer, an extended causal convolution layer, a residual connection block, a first full connection layer, a first activation function layer, a second full connection layer, a second activation function layer, and a third full connection layer, which are sequentially connected.

9. The method for the short-term wind power prediction of the newly-built wind farm based on sample migration according to claim 1, wherein the setting the training loss function, training the constructed wind power prediction neural network model, and using the similarity weight sequence to optimize the network model parameters to obtain the trained wind power prediction neural network model comprises:
setting the training loss function:
$${MSEloss}_{G} = \frac{1}{G} {\sum }_{g = 1}^{G} ( {y}_{g}^{train} - {\hat{y}}_{g}^{train} )$$
wherein MSEloss_{G} represents a training loss function value, G represents a number of samples in a current batch input sequence, y_{g}^{train} represents a g^{th} wind power prediction value in the current batch input sequence, and g represents a g^{th} wind power target value in the current batch input sequence; and
calculating a training loss function value corresponding to the training according to the training loss function; setting an upper limit of iterative training times, and when the training times reach the upper limit of the training times, multiplying the training loss function value corresponding to each training by a similarity weight in the similarity weight sequence to obtain a weighted training loss function value; and storing the network model parameters corresponding to the minimum weighted training loss function value as optimal network model parameters to obtain the trained wind power prediction neural network model.
